(19) United States
(12) Patent Application Publication
(10) Pub. No.: US 2002/0029635 A1
(43) Pub. Date: Mar. 14, 2002

(54) Measuring devices

(76) Inventor: Harriet G. Kremen, Lincolnwood, IL (US)

Correspondence Address: Edward Langer. Pat. Atty., c/o Landon & Stark Associates, One Crystal Park, 2011 Crystal Drive, Suite 210, Arlington, VA, 22202, US

(21) Appl. No.: 09/811,818

(22) Filed: Mar. 20, 2001

Related U.S. Application Data
(60) Provisional application No. 60/199,135, filed on Apr. 24, 2000.

(51) Int. Cl. G01F 19/00

(52) U.S. Cl. 73/426

(57) ABSTRACT

Service items, such as cups and the like, and utensils, such as spoons and the like are configured such that with food or medicine, typically liquid or solid, can be initially measured and consumed therefrom. These devices can be made of materials, whereby they are disposable and for a single use, so as to be highly sanitary.

### FIELD OF THE INVENTION

The present invention is related to measuring devices and particular to measuring devices suitable for single or multiple uses that may be used in their present state for the consumption (ingestion) of the contents being measured thereby.

### BACKGROUND OF THE INVENTION

Many times, people need to know exact portions or amounts of food, medicine, etc, that they wish or need to take. This is especially true for people on diets, or those who must administer medicines to themselves regularly, or in some cases both, for example, when the person is diabetic.

This typically requires the use of measuring devices, such as measuring cups or graduated spoons. When a user wishes to administer the requisite food or medicine portion, in solid or liquid form, to themselves or another, they must make a first transfer of the food or medicine into the measuring cup or spoon, followed by a second transfer, from the measuring cup or spoon to the service device, such as a standard table cup or spoon, from which the food or medicine will ultimately be ingested or consumed.

This results in a waste of resources, as the measuring cup or spoon must be cleaned if further uses is desired, as well as the use of the second service device. Moreover, in transferring the food or medicine from the measuring cup or spoon to the second service device, some or all of the continents of the food or medicine being transferred may be lost, thus user may not obtain the amount of food or medicine necessary or as originally desired.

### SUMMARY OF THE INVENTION

The present invention overcomes the problems of the conventional art by providing a single device from which food or medicine, typically liquid or solid, can be initially measured and consumed therefrom. This saves resources as well as insures greater accuracy in amounts to be ingested or consumed, as the transfer between measuring device and service item or utensil, has been eliminated. Moreover, the devices of the present invention can be made of materials, whereby they are disposable and for a single use, so as to be highly sanitary.

In an embodiment of the invention, there is disclosed a service item, such as a cup, having a body including at least a portion that is at least translucent. There is at least one indicia at least proximate to this translucent portion, this at least one indicia corresponding to a liquid volume. The at least one indicia could be a marking, embossment indentation or the like so as to be visible and/or tactile, thus allowing the user greater assurance in measuring.

Another embodiment of the invention is directed to a utensil, and for example, a spoon having a first end including a handle portion, and a second end including a holding portion, for materials, solid and liquid. The holding portion is in communication with the handle portion, and this holding portion has single or multiple indicia thereon, each of the indicia corresponding to a predetermined volume, typically a liquid volume. The indicia could be a marking, embossment, indentation or the like, so as to be visible and/or tactile, thus allowing the user greater assurance in measuring.

### BRIEF DESCRIPTION OF THE DRAWINGS

The present invention will be described with reference to the attached drawings, where like reference numerals or characters indicate corresponding or like components. In the drawings:

FIG. 1A is a perspective view of a first embodiment of the present invention in the form of a cup;

FIG. 1B is a side view of the cup of the embodiment of FIG. 1A;

FIG. 1C is a perspective view of an alternate embodiment of the cup of FIG. 1A; and

FIG. 2 is a second embodiment of the present invention in the form of a utensil.

### DETAILED DESCRIPTION OF THE DRAWINGS

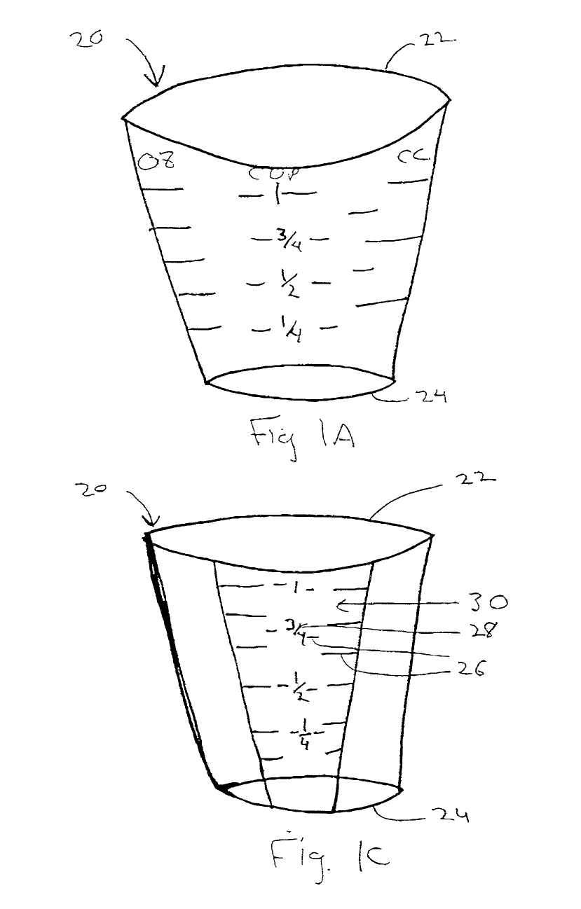

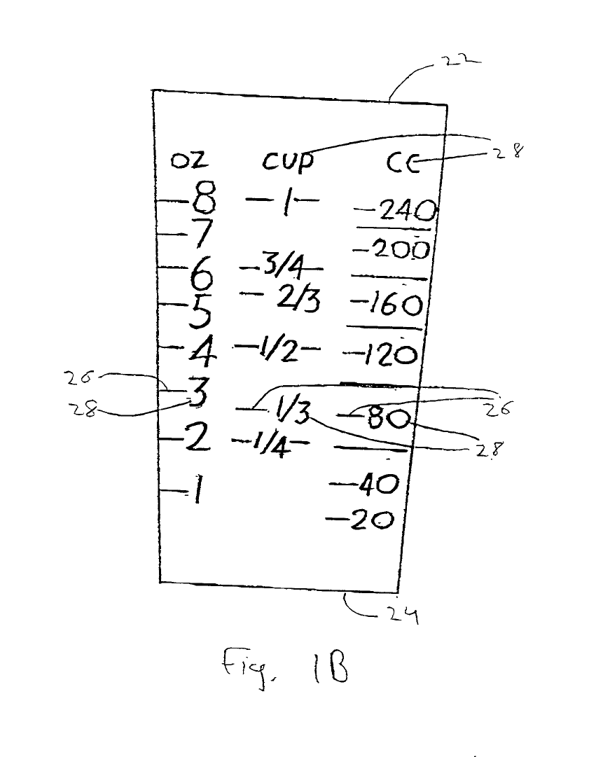

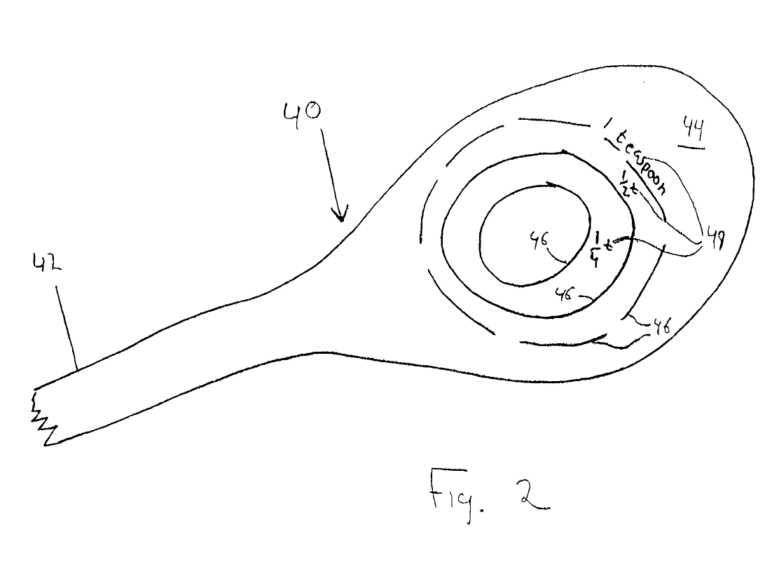

FIGS. 1A and 1B detail a first embodiment of the present invention in the form of a cup 20. This cup 20 is exemplary only, as other service items may also be produced in accordance with the description herein. This cup 20 is of a standard size, and is typically of lightweight materials, such as paper, plastics, or the like, so as to make the cup disposable upon a single use, if desired. The materials above, when configured as the cup 20, are at least translucent, or alternately, may include at least a translucent portion thereof 30 (FIG. 1C detailed below), extending preferably from the upper end 22 to the lower end 24. This construction enables the user to view the level of the substances placed into the cup 20, with respect to the indicia 26.

Indicia 26 are typically in the form of graduations, and may also include numerals 28, characters (for example, abbreviated words, whole single or multiple words, word portions, or combinations thereof), symbols or the like accompanying any or all of the indicia 26. These indicia 26 are configured on the cup 20 to correspond to volumes, preferably liquid volumes, typically in metric and/or English units, the volumes typically on the cup 20, as specified by the numerals 28, characters, symbols or the like.

The indicia 26 are typically in the form of printed markings, embossments (protrusions) or indentations, and can be placed onto the cup 20, by conventional printing, embossing or indentation techniques, so as to be visible and/or tactile. These indicia 26 and/or portions thereof may extend around the cup in a continuous or noncontinuous manner, or alternately, can be partial, along a portion or portions of the cup 20. When the cup 20 includes a clear or translucent portion, the clear or translucent portion may include indicia 26 (and numerals 28, characters, symbols, or the like, as detailed above) or the indicia 26 (and numerals 28, characters, symbols, or the like, as detailed above) may be placed proximate thereto.

The indicia 26, and numerals 28, characters, symbols, or the like may also be in the same or different colors, to emphasize different volumes, and the numerals 28, characters or symbols can be in configurations such as Braille.

Turning to FIG. 1C, there is shown a cup 20, constructed as detailed above, with a portion 30, typically a panel, that is at least translucent as detailed above. This portion 30 may include all or portions of the indicia 26 and associated numerals 28, characters, symbols or the like as detailed above, and typically extends from the upper end 22 to the lower end 24 of the cup 20. This portion 30 can also be of clear plastic, to be transparent or nearly transparent, with the remainder of the cup made of paper, plastic or the like, that need not be at least translucent.

FIG. 2 details a utensil, for example, a spoon 40, as a second embodiment of the present invention. The spoon could be a conventional tea, table or dessert spoon, but any sized spoon or other similar service device is permissible. This spoon 40 is exemplary only, as other utensils may also be produced in accordance with the description herein. The spoon 40 typically includes a handle 42 at one end and a holding portion 44 at the other. The holding portion 44 is typically bowled downward (inward), to hold materials, typically solids or liquids.

Indicia 46 are within this holding portion 44. These indicia 46 are in accordance with the indicia 26 detailed above, and are positioned on the holding portion 44, to correspond to volumes, typically liquid volumes, typically in metric and/or English units. Any or all of the indicia 46 can be accompanied by numerals 48, characters, symbols, or the like, in accordance with the numerals 28, characters, symbols, as detailed above, to indicate the respective volumes of the indicia 46.

The indicia 46 includes portions that are preferably continuous, but could be noncontinuous, for example, broken or incomplete lines or general lines, or even partial or segmental, as long as they are visible and/or tactile, so as to be recognizable to the user. These indicia portions may be in various shapes extending along the holding portion, and for example, can be circular, oval, or rounded, so as to correspond to the overall shape of holding portion 44. The indicia 46, can be arranged on the holding portion 44 so as to be graduated, representing different volumes.

The indicia 46, and numerals 48, characters, symbols, or the like may also be in the same or different colors, to emphasize different volumes, and the numerals 28, characters or symbols can be in configurations such as Braille.

While preferred embodiments of the present invention have been described so as to enable one skilled in the art to practice the invention, the preceding description is intended to be exemplary and should not be used to limit the scope of the invention.

This scope of the invention should be determined by reference to the following claims.

What is claimed is:

1. A utensil comprising:
a first end including a handle portion; and
a second end including a holding portion, said holding portion in communication with said handle portion, said holding portion comprising, at least one indicia thereon, said at least one indicia corresponding to a predetermined fluid volume.

2. The utensil of claim 1, wherein said at least one indicia extends along said holding portion substantially continuously.

3. The utensil of claim 2, wherein said at least one indicia is selected from the group comprising: markings, embossments and indentations.

4. The utensil of claim 3, wherein said at least one indicia includes a plurality of indicia.

5. The utensil of claim 1, wherein said at least one indicia includes a plurality of indicia.

6. The utensil of claim 1, wherein said predetermined fluid volume includes a predetermined liquid volume.

7. The utensil of claim 1, wherein said first and second ends define a spoon.

8. A service item comprising:
a body including at least a portion that is at least translucent; and
at least one indicia at least proximate to said at least a translucent portions said at least one indicia corresponding to a liquid volume.

9. The service item of claim 8, wherein said service item includes a cup.

10. The service item of claim 9, wherein said at least one indicia is selected from the group comprising: markings, embossments and indentations.

11. The service item of claim 10, wherein said at least one indicia includes a plurality of indicia.
